(19) United States
(12) Patent Application Publication
(10) Pub. No.: US 2012/0008664 A1
(43) Pub. Date: Jan. 12, 2012

(54) DEVICE FOR CONTROLLING THE FREQUENCY OF A SATELLITE REMOTE-CONTROLLED TRANSMITTER/RECEIVER, AND RELATED TRANSMITTER AND RECEIVER

(75) Inventors: Rodolphe Nasta, Toulouse (FR); Thierry Populus, Fontenilles (FR)

(73) Assignee: THALES, NEUILLY-SUR-SEINE (FR)

(21) Appl. No.: 13/256,612

(22) PCT Filed: Mar. 15, 2010
(86) PCT No.: PCT/EP2010/053294

§ 371 Date: Sep. 14, 2011

(30) Foreign Application Priority Data
Mar. 17, 2009 (FR) 0901235

(51) Int. Cl. H04L 25/60

(52) U.S. Cl. 375/214

(57) ABSTRACT

Device for controlling a frequency F of a TTC satellite link transmitter and/or receiver on the basis of a frequency command whose value is taken in a predetermined frequency plan composed of several frequency notches distributed in a discontinuous manner in a given frequency band, said device including a quartz oscillator delivering a reference frequency F_{OCXO}, a synthesized local oscillator delivering said frequency F on the basis of said reference frequency F_{OCXO} according to a relation

$$F = {F}_{OCXO} \frac{N}{R}$$

where N and R are programmable divider coefficients, and a digital integrated circuit which implements a conversion table mapping each frequency notch of said predetermined frequency plan to a set of binary addresses distributed in a contiguous manner addressing the values of said coefficients N and R in the form of binary words allowing the synthesized local oscillator to generate said frequency F whose value is equal to that of said frequency command.

The present invention relates to a frequency control device for a satellite remote-control receiver or a satellite telemetry transmitter.

The transmitter/receiver assembly is situated aboard a geostationary or flyby satellite and implements a link for telemetry, remote control and measurement of distance between the ground stations and said satellite. This link is known by the term TTC link, the acronym standing for Telemetry, Tracking and Command, or by the term TCR (Telemetry, Command and Ranging) link. This link is used in particular for the remote control of the satellite from the Earth but also for telemetry, that is to say for the transmission from the satellite of information about the state of the craft. More precisely, the satellite remote-control link corresponds to the uplink between a ground transmitter, and a receiver aboard the satellite. The telemetry link corresponds to the downlink between a telemetry transmitter situated aboard the satellite and a receiver situated in a ground station.

In the subsequent description the acronym TTC is used as reference to the link of the same name. A TTC transmitter designates a telemetry transmitter and a TTC receiver designates a remote-control receiver, both items of equipment being situated aboard a satellite.

The known solutions of TTC transmitter/receiver architectures use a local oscillator which usually delivers a fixed frequency or a restricted number of frequencies. This frequency may nonetheless be rendered programmable through the use of a fractional synthesizer. The span of variation of the frequency is generally very significant and its programming is done on the basis of a constant frequency increment, thereby ultimately giving rise to a high number of potential frequencies, this number being equal to the length of the span in which the frequency can vary, divided by the frequency increment used. This possibility of reconfiguring the initially fixed frequency makes it possible for example to coordinate the frequencies of several satellites upon a change of orbital position or to avoid certain jammed frequencies. One of the major drawbacks of TTC architectures with conventional fractional synthesizer is the very significant number of programmable frequencies that must be taken into account by the synthesizer. By way of example, for a Ku frequency band, a fractional synthesizer can implement 500 000 different frequencies so as to cover a total band of 750 MHz. This capacity of the synthesizer to be able to generate a large number of different frequencies exhibits several drawbacks.

Firstly the significant number of available frequencies makes it impossible to exhaustively validate the operation of the control of all these frequencies in respect of the TTC transmitter or receiver. Moreover, among the set of available frequencies, some are not usable since they correspond to frequency bands allocated to another telecommunication channel, the effect of which is to give rise to false-alarm problems. Indeed any false control command for the frequency may culminate in a critical configuration where the TTC receiver operates at a prohibited frequency since the latter is, for example, superimposed on a frequency dedicated to another communication link.

The use of an intelligent programmable frequency synthesizer whose function is to frequency-control a TTC receiver or transmitter makes it possible to alleviate the problems mentioned above. In particular, the solution adopted by the invention consists in implementing jointly with the programmable frequency synthesizer, an intelligent frequency control device whose frequency intervals are not systematically regular but make it possible to meet precise requirements specified by the user relating to the use of the frequency band allocated to the TTC link. For this purpose, the subject of the present invention is notably a device for controlling the frequency of a TTC transmitter or receiver implementing an intelligent frequency command whose function is to control a local oscillator so that it generates a value taken from a specified frequency span rather than over the entire frequency band allotted to satellite radiobroadcasting services.

For this purpose, the subject of the invention is a device for controlling the frequency F of a TTC satellite link transmitter and/or receiver on the basis of a frequency command whose value is taken in a predetermined frequency plan composed of several frequency notches distributed in a discontinuous manner in a given frequency band, said device being characterized in that it comprises at least one quartz oscillator delivering a reference frequency F_{OCXO}, a synthesized local oscillator delivering said frequency F on the basis of said reference frequency F_{OCXO} according to the following relation

$$F = {F}_{OCXO} \frac{N}{R}$$

where N and R are programmable divider coefficients and a digital integrated circuit which implements a conversion table mapping each frequency notch (503,504,505) of said predetermined frequency plan to a set of binary addresses distributed in a contiguous manner addressing the values of said coefficients N and R in the form of binary words allowing the synthesized local oscillator (101) to generate said frequency F whose value is equal to that of said frequency command.

In a variant embodiment, said digital integrated circuit is a programmable-logic component or a read-only memory.

The subject of the invention is also a remote-control receiver for a geostationary satellite comprising at least one amplification and filtering analog input circuit, a first frequency conversion chain delivering at its output a signal at a first intermediate frequency and a digital demodulation circuit characterized in that said first frequency conversion chain comprises at least one mixer, an amplification and filtering circuit and a frequency control device such as described above.

In a variant embodiment, said receiver additionally comprises a second frequency conversion chain receiving as input the output signal of said first frequency conversion chain and delivering to said demodulation circuit a signal at a second intermediate frequency.

The subject of the invention is also a telemetry transmitter for a geostationary or flyby satellite comprising at least one modulation circuit, an amplification and filtering circuit and a device for controlling the frequency of said transmitter such as described above.

Other characteristics and advantages of the present invention will be more apparent on reading the description which follows in conjunction with the appended drawings which represent:

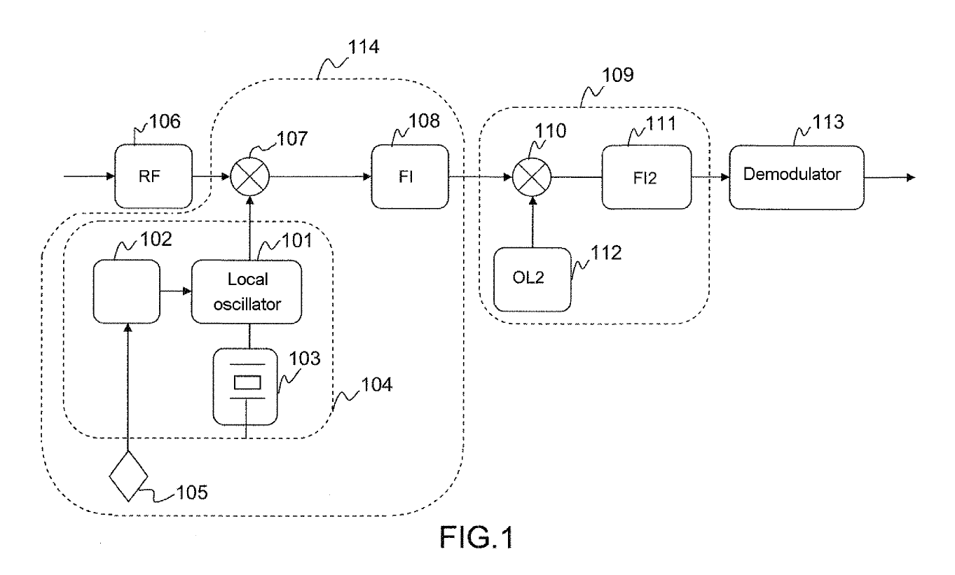

FIG. 1, a schematic of a satellite remote-control receiver frequency-controlled by a device according to the invention,

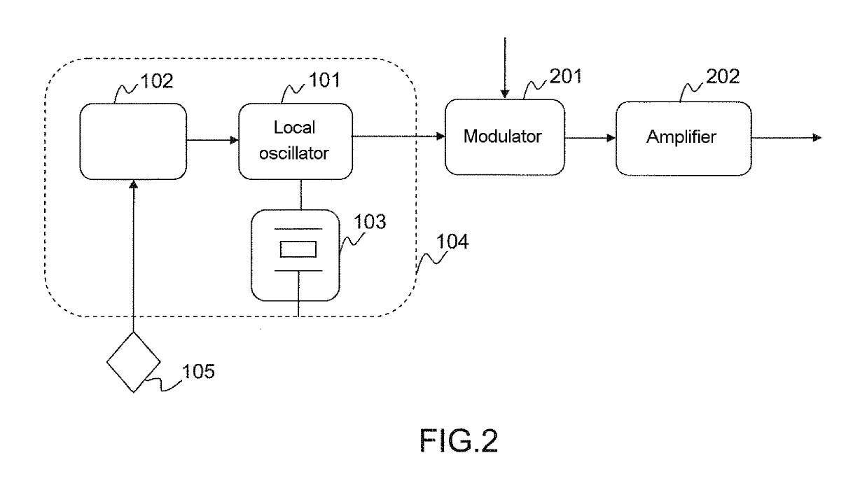

FIG. 2, a schematic of a satellite telemetry transmitter frequency-controlled by a device according to the invention,

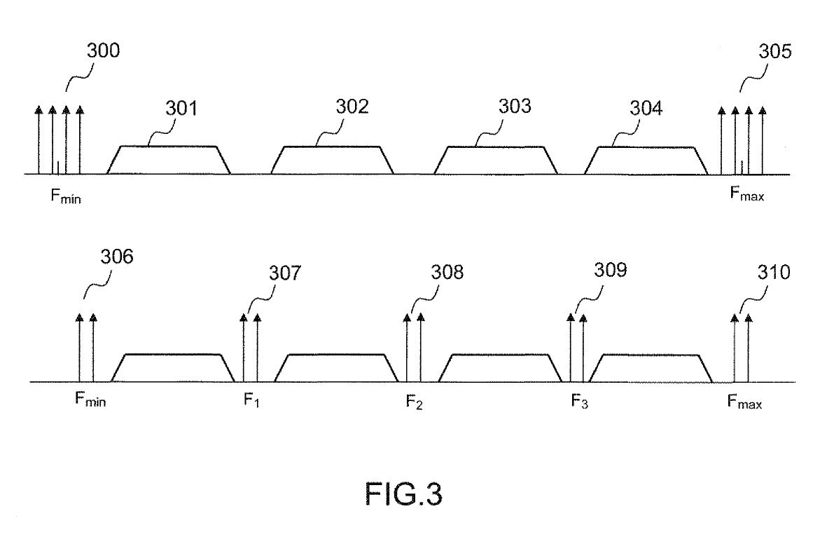

FIG. 3, a diagram of an exemplary plan of the control frequencies making it possible to avoid occupied communication channels,

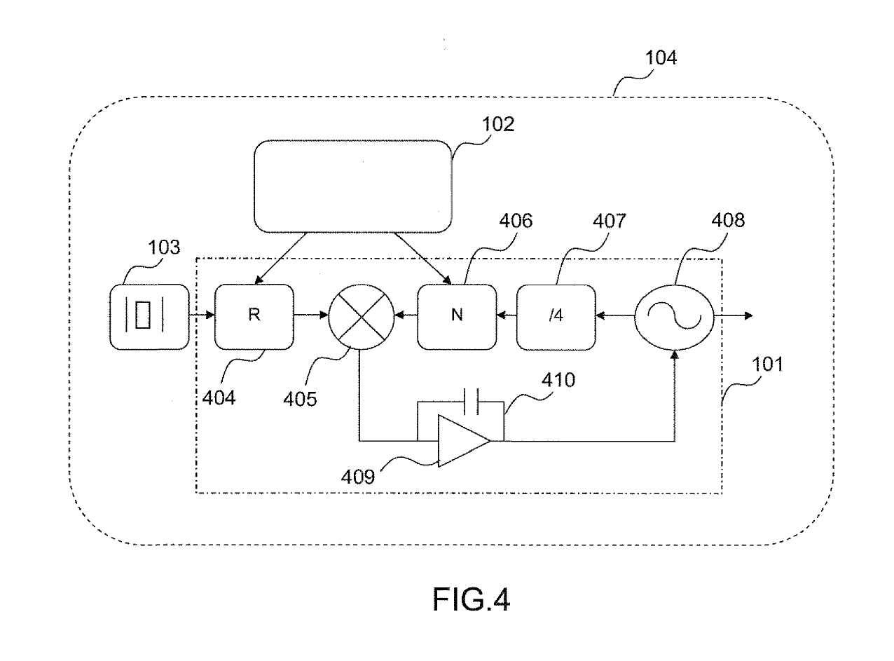

FIG. 4, a schematic of the frequency control device according to the invention,

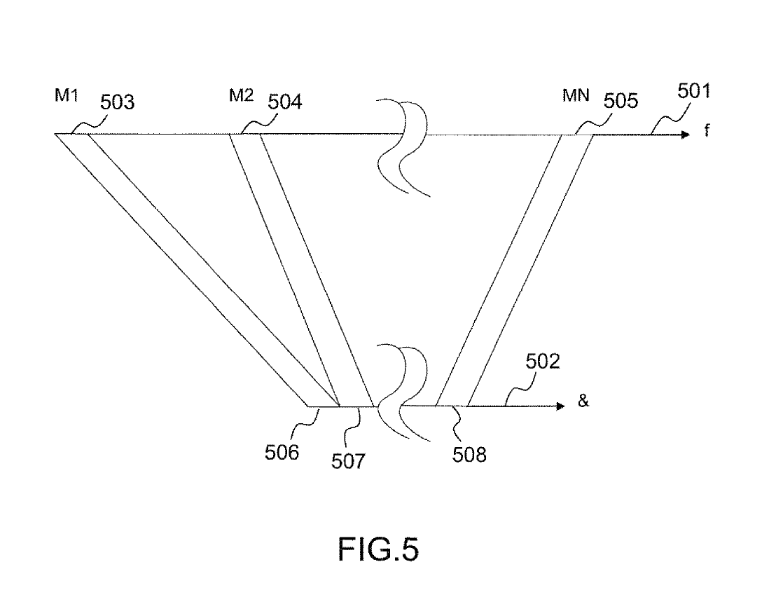

FIG. 5, a diagram illustrating the principle of converting frequency notches into binary addresses.

FIG. 1 represents a block diagram of a TTC satellite link receiver according to the invention.

This receiver is composed essentially of the following elements:
a set of analog input circuits 106 whose function is mainly the amplification and the filtering of the input signal and secondarily the impedance matching of said signal,
a frequency mixer 107 associated with a frequency control device 104 according to the invention and with a set of amplification and filtering circuits 108. These three elements constitute a first chain for transferring to intermediate frequency whose function is to convert the frequency of the input signal to the intermediate frequency delivered by the control device 104,
a second chain for transferring to intermediate frequency 109, which can be optional, consisting of a frequency mixer 110, of a local oscillator 112 delivering a fixed frequency and of an amplification circuit 111,
a digital demodulation circuit 113 whose function is to demodulate the signal received so as to recover the data transmitted.

The frequency control device 104 mainly comprises a conversion circuit 102 which receives as input a frequency command 105 and which is able to digitally control a synthesized local oscillator 101 whose function is to deliver the frequency of said satellite remote-control receiver, which is thereafter delivered as input to the mixer 107. The synthesized local oscillator 101 is also linked to a quartz oscillator 103 whose function is to deliver a reference frequency on the basis of which the synthesized local oscillator 101 generates the frequency of the satellite remote-control receiver.

FIG. 2 represents a block diagram of the architecture of a TTC satellite link transmitter or telemetry transmitter according to the invention. This architecture is composed essentially of the following elements:
a frequency control device 104 such as described above whose function is to generate the frequency of the telemetry transmitter. This device 104 is mainly composed of a conversion circuit 102 reacting to a frequency command 105, of a synthesized local oscillator 101 and of a quartz oscillator 103,
a modulation circuit 201 whose function is to modulate the input signal at the frequency generated by the control device 104,
one or more amplification and filtering circuits 202 which, on the basis of the modulated signal, generate an analog signal to be transmitted.

FIG. 3 shows schematically an exemplary control frequencies distribution plan according to the invention. A communication band, for example a Ku band used by the satellite communication systems comprises telecommunication channels 301, 302, 303, 304 occupied by transmissions other than that relating to the TTC satellite link. The invention consists in limiting the field of the possible frequencies for the remote-control receiver to certain frequencies that are not used in the communication band and are specified by the requirements of the system. For example, the frequency notches 300,305 situated around the minimum Fₘᵢₙ and maximum Fₘₐₓ frequencies of the communication band or the frequency notches 306,307,308,309,310 situated between the occupied telecommunication channels may be adopted in the plan of the frequencies for which the receiver according to the invention must be capable of operating. Generally, it is possible to define N frequency notches Sᵢ, 1≦i≦N inside the communication band considered which may be, for example, a Ku, K or Cband. Each of said notches Sᵢ may contain a variable number of frequencies Mᵢ distributed in a regular or irregular manner. The total number M of programmable frequencies at which the remote-control receiver or the telemetry transmitter according to the invention must operate is therefore equal to the sum of the number of frequencies of each notch, according to the following relation:

$$M = {\sum }_{i = 1}^{N} {M}_{i}$$

The aim of programming the frequency of the receiver according to this frequency plan is to limit the possible frequencies to the notches available and required by the user.

FIG. 4 shows schematically a detailed block diagram of the frequency control device 104 whose function is to generate the operating frequency of the remote-control receiver or of the telemetry transmitter according to the invention. This control device 104 comprises notably a quartz oscillator 103 the function of which is to deliver a fixed reference frequency denoted F_{OCXO} to a synthesized local oscillator 101 also called a frequency synthesizer. This quartz oscillator 103 is, for example, a thermostatically-controlled quartz oscillator or OCXO. The frequency synthesizer 101 comprises a frequency division device 404 for dividing by an integer factor R, a mixer 405 which makes it possible to combine the output frequency of the frequency divider device 404 with that delivered as output from a second frequency divider device 406 of division rank N (where N may be fractional) and a frequency slaving device 409 which links the output of the mixer 405 with the input of a voltage controlled oscillator 408 better known by the acronym VCO. The voltage controlled oscillator 408 delivers at its output a frequency F_{VCO} which is related to the reference frequency of the quartz oscillator 403 by the following relation:

$${F}_{VCO} = {F}_{OCXO} \cdot \frac{N}{R}$$

A digital integrated conversion circuit 102 carrying out the control of the frequency of the receiver according to the invention acts on the dividers 404 and 406 so as to determine the values of N and R making it possible, on the basis of relation (1), to generate the desired frequency. This digital integrated circuit may be a programmable logic component, a read only memory or any other device making it possible to deliver digital words at its output. The function of this digital integrated circuit is to control the frequency dividers 404,406 of the local oscillator according to the invention so as to cause them to apply the values of the coefficients N and R making it possible to generate the whole set of frequencies of the frequency plan such as described in FIG. 2. Accordingly, said digital integrated circuit 402 implements a conversion table the function of which is to associate a binary address with each frequency of the frequency plan adopted. The set of binary addresses must constitute a contiguous set so as to limit the choice of frequencies to the strict requirement. Each binary address is mapped to a corresponding programming word containing the values of the coefficients N and R which are also stored within the circuit 102. The advantage of this solution is to restrict the number of addresses to be programmed solely to the programmable frequencies specified and actually used by the TTC satellite link transmitter/receiver. By way of example, a receiver capable of operating at 32 different frequencies requires a field of programming addresses that is limited to 5 bits whereas for a fractional synthesizer of the state of the art operating in the Ku band, the programming of 500,000 frequencies requires 19 bits.

FIG. 5 shows schematically the conversion principle implemented by the conversion circuit 102 according to the invention. A set of frequency notches 503, 504, 505 is represented, these notches being distributed over the frequency axis 501 in a discontinuous manner. Each notch contains a different number of frequencies, the first notch 503 contains M₁ frequencies distributed within the notch in a continuous or discontinuous manner, the second notch 504 contains M₂ frequencies and the nth notch 505 contains Mₙ frequencies. The conversion circuit 102 associates a group of binary addresses with each of said notches, the set of groups of addresses being distributed in a continuous manner over the binary address axis 502. The conversion circuit 102 associates a first group of binary addresses 506, comprising a span of addresses ranging from 0 to M₁−1, with the first frequency notch 503. The second frequency notch 504 is represented by a group of addresses 507 whose values range from M₁ to M₁+M₂−1 and so on and so forth for each group of addresses obtained by converting a frequency notch.

By way of example, the frequency notch 503 can contain the following frequencies f₁=13751.1 MHz, f₂=13751.2 MHz, f₃=13751.5 MHz and f₄=13751.6 MHz which are not necessarily equidistributed. The conversion circuit 102, for this example, maps the address 0 to the pair of digital words (N₁,R₁) allowing the synthesized local oscillator to generate the frequency f₁. In a similar manner, the addresses 1, 2 and 3 are mapped to the pairs of digital words (N₂,R₂), (N₃,R₃), (N₄,R₄) making it possible to generate the frequencies f₂, f₃ and f₄.

The programming of the digital conversion table implemented by the conversion circuit 102 is such that to any address there corresponds a useful frequency of the receiver (or of the transmitter) for remote control (or for telemetry) according to the invention. This conversion table maps a binary address provided as input, with the programming words necessary for the control of the associated frequency of the synthesizer.

One of the advantages of the invention resides in the fact of limiting the set of possible frequencies at which the remote-control receiver or the telemetry transmitter can operate. The use of a frequency control device making it possible to program, with the aid of a conversion table, the set of authorized operating frequencies makes it possible to considerably lighten the testability of the TTC equipment. Moreover, the invention also makes it possible to avoid the use of an unauthorized frequency, for example a frequency that might already be used by another type of transmission. In the case of satellite applications, the device according to the invention makes it possible to generate frequencies whose values are limited to the strict usage of the frequency plan. The set of frequencies that can be generated may be seen as a frequency mask matched to the frequency plan of the system aimed at. Such a mask may be readily modified if the frequency plan changes. For this purpose it suffices to update the device conversion table.

Finally the use of a digital integrated circuit to render the frequency programmable makes it possible to easily carry out a change of frequency in the course of the lifetime of the satellite, which cannot easily be carried out with an architecture of the state of the art, notably in the case of satellites that are not equipped with any series link to the equipment and for which the changes of state of the frequency are carried out by incrementation or decrementation of the control words.

1. A device for controlling a frequency F of a TTC satellite link transmitter and/or receiver on the basis of a frequency command whose value is taken in a predetermined frequency plan composed of several frequency notches distributed in a discontinuous manner in a given frequency band, said device comprising:
a quartz oscillator delivering a reference frequency F_{OCXO};
a synthesized local oscillator delivering said frequency F on the basis of said reference frequency F_{OCXO} according to a relation F=F_{OCXO}N/R where N and R are programmable divider coefficients; and
a digital integrated circuit which implements a conversion table mapping each frequency notch of said predetermined frequency plan to a set of binary addresses distributed in a contiguous manner addressing the values of said coefficients N and R in the form of binary words allowing the synthesized local oscillator to generate said frequency F whose value is equal to that of said frequency command.

2. The device according to claim 1, wherein said digital integrated circuit is a programmable-logic component or a read-only memory.

3. A remote-control receiver for a geostationary satellite comprising:
an amplification and filtering analog input circuit;
a first frequency conversion chain delivering at its output a signal at a first intermediate frequency; and
a digital demodulation circuit; wherein
said first frequency conversion chain comprises:
a mixer,
an amplification and filtering circuit, and
a device for controlling the frequency according to claim 1.

4. The remote-control receiver for a geostationary or flyby satellite according to claim 3, wherein said receiver additionally comprises
a second frequency conversion chain receiving as input the output signal of said first frequency conversion chain and delivering to said demodulation circuit a signal at a second intermediate frequency.

5. A telemetry transmitter for a geostationary or flyby satellite comprising:
a modulation circuit;
an amplification and filtering circuit; and
a device for controlling the frequency of said transmitter according to claim 1.
